(19) United States
(12) Patent Application Publication
(10) Pub. No.: US 2012/0188333 A1
(43) Pub. Date: Jul. 26, 2012

(54) SPHERICAL VIEW POINT CONTROLLER AND METHOD FOR NAVIGATING A NETWORK OF SENSORS

(75) Inventors: Alexander M. Morison, Columbus, OH (US); David D. Woods, Columbus, OH (US); Axel Roesler, Seattle, WA (US)

(73) Assignee: THE OHIO STATE UNIVERSITY, Columbus, OH (US)

(21) Appl. No.: 12/789,030

(22) Filed: May 27, 2010

Related U.S. Application Data
(60) Provisional application No. 61/181,427, filed on May 27, 2009.

(51) Int. Cl. H04N 7/00; H04N 7/18

(52) U.S. Cl. 348/39; 348/143; 348/36; 348/E07.001; 348/E07.085

(57) ABSTRACT

An improved human-sensor system for allowing an observer to efficiently perceive, navigate, and control a sensor network. A first layer of the system is a spherical control interface that independently provides an indication of the orientation of a sensor being controlled by the interface. A second layer of the system enhances a live sensor feed by providing a virtual, environmental context when the feed is displayed to an observer. A third layer of the system allows an observer to switch from a first-person perspective view from a sensor to a third person perspective view from movable point of observation in virtual space. A fourth layer of the system provides a virtual representation of the sensor network, wherein each sensor is represented by a virtual display medium in a virtual space. A fifth layer of the system provides a methodology for navigating and controlling the virtual sensor network of Layer 4.

### CROSS-REFERENCES TO RELATED APPLICATIONS

This application claims the benefit of U.S. Provisional Application No. 61/181,427 filed May 27, 2009.

### STATEMENT REGARDING FEDERALLY-SPONSORED RESEARCH AND DEVELOPMENT

This invention was made with Government support under contract GRT869003 awarded by the Army Research Laboratory. The Government has certain rights in the invention.

### REFERENCE TO AN APPENDIX

(Not Applicable)

### BACKGROUND OF THE INVENTION

The present invention generally relates to the field of human-sensor systems, and relates more particularly to an improved human sensor system that includes a spherical user control interface and a virtual sensor network representation for allowing an observer to efficiently perceive, navigate, and control a sensor network.

Traditional human-sensor systems, such as conventional video surveillance networks, fundamentally include at least one remotely-located sensor, such as a video surveillance camera or a RADAR, SONAR or infrared (IR) sensing unit, a control device, such as a joystick or a computer mouse for allowing a human observer to control the movements of the sensor, and a display medium, such as a computer monitor for displaying the output of the sensor to the observer. Human-sensor systems commonly incorporate numerous remotely-located sensors in such a manner, wherein the outputs of the sensors are displayed on an organized array of monitors at a central location. Such systems enable human observers to selectively view distant environments that may be located many miles away and spread out over large areas. A “distant environment” is defined herein to mean a physical scene of interest that is outside of an observer's direct perceptual range. Generally, each sensor in a conventional multi-sensor network is assigned an alphanumeric label for allowing a human observer to selectively control, and identify the output of, each sensor.

Several limitations of traditional human-sensor systems stem from the reliance of such systems on joysticks and other conventional control interfaces. A conventional joystick, for example, provides the two degrees of freedom that are necessary to control the orientation of a conventional pan-tilt-zoom (PTZ) video surveillance camera. By deflecting a joystick left, right, forward, and rearward from center, a user of the joystick can cause a PTZ camera to pan (i.e., rotate left and right about a vertical axis) and tilt (i.e., rotate down and up about a horizontal axis), respectively. However, a joystick creates an ambiguous control mapping from a user's input to the resulting movement of the camera. That is, when the joystick is deflected by a user, the camera is camera is caused to move with a particular velocity. The larger the deflection, the greater the velocity. The specific relationship between the degree of deflection of the joystick and the velocity of the camera is typically defined by a programmer of the sensor system or another individual and is often non-linear. Predicting the distance that the camera will move requires integrating the camera's velocity over time. A user having no prior familiarity with the sensor system therefore cannot accurately predict the magnitude of the camera's movement in response to a particular deflection of the joystick. A certain amount of experimentation would be necessary for the user to become familiar with the behavior of the control relationship. Even an experienced user of the system must perform some mental calculations and recall previous behavior of the system to manipulate the camera's position in a desired manner. This can be problematic in situations where signal delays exist or a user is required to operate the sensor system with a high degree of speed and confidence, such as to track a fleeing crime suspect or to survey movements on a battle field.

Another limitation associated with joysticks and other conventional control devices is that such devices provide no external indication of the relative orientation of a sensor being controlled by the device. For example, if a joystick is being used to control a remotely-located surveillance camera, it is impossible for an observer to determine the orientation of the camera by looking only at the joystick. Indeed, the only observable quality of the temporal state of a joystick is the existence or lack of deflection in a particular direction, which is only useful for determining whether or not the camera is currently moving in a particular direction. In order to determine the orientation of the camera, an observer is therefore required to view the output of the camera on a monitor, and perhaps even manipulate the orientation of the camera with the joystick to scan the camera's surrounding environment to establish a relative sense of placement of the scene being viewed. Even still, if the observer is unfamiliar with the orientation of the environment under surveillance relative to cardinal directions, it will be difficult for the observer to accurately determine the cardinal direction in which the camera is pointing.

Empirical studies of human scene recognition demonstrate that different perceptual mechanisms underlie changes in viewpoint versus object rotations. In current human-sensor systems, movement of sensors is based on object-centered rotations that are often generated through a joystick-type input device. A perceptual motivated human-sensor system will instead utilize viewpoint as the observer controlled input (Simons and Wang, 1998; Wang and Simons, 1999). The perspective control approach, instead, utilizes viewpoint control as the method for controlling and representing sensor data. Based on the findings of Simons and Wang, this viewpoint control approach for human-sensor systems takes advantage of the underlying perceptual mechanisms associated with apprehension of a scene through movement of a physical viewpoint.

Additional short comings of traditional human-sensor systems stem from the manner in which sensor feeds are displayed to users of such systems. For example, the video feed from a conventional PTZ camera provides a relatively narrow field of view (e.g., 50 degrees×37 degrees) compared to the total pan and tilt range of the camera (e.g., 360 degrees×180 degrees). This video feed is generally the only visual information provided to an observer and does not inform the observer of the camera's total viewable range (i.e., a hemisphere). That is, an observer having no prior familiarity with the sensor system would not know how far the camera could pan or tilt without actually engaging the control device and moving the camera to the boundaries of its viewable range. Even if the range is known, spatial relationships between consecutive views, such as behind, to the right of, to the left of, and below, are obscured from the user. It can therefore be extremely time-consuming and cumbersome for a user to ascertain a sensor's range of motion and/or to anticipate changes in view.

The challenges associated with current methods for displaying sensor data are multiplied in human-sensor networks that incorporate a large number of sensors. As briefly described above, such human-sensor systems typically incorporate a “wall of monitors” approach, wherein sensor data, such as a plurality of camera feeds, is displayed on a set of physical monitors that are spread out over a physical area (e.g., a wall). These physical monitors can vary in size and are often subdivided into virtual sub-monitors to expand the number of available display locations. For example, 10 physical monitors may be used to display 40 sensor feeds if each physical monitor is subdivided into 4 virtual monitors (i.e., four adjacent, rectangular display areas within the same physical monitor). Each of these virtual monitors serves as a generic container in which any of the sensor feeds can be displayed.

While the generic quality of traditional display means provides conventional sensor systems with a certain level of versatility, it also necessarily means that no explicit relationships exist across the set of displayed sensor feeds. That is, an observer viewing two different display feeds showing two different, distant environments would not be able to determine the spatial relationship between those environments or the two sensors capturing them unless the observer has prior familiarity with the displayed environments or uses an external aid, such as a map showing the locations of the sensors. Even if the observer has prior familiarity with the environments being viewed, he or she would still have to perform mental rotations and calculations on the observed views to approximate the relative positions and orientations of the sensors. Again, performing such a deliberative, cognitive task can be time-consuming, cumbersome, and therefore highly detrimental in the context of time-sensitive situations.

A further constraint associated with the traditional “wall of monitors” display approach is the limited availability of display space. The total number of virtual monitors defines the maximum number of simultaneously-viewable sensor feeds, regardless of the total number of sensors in a network. For example, if a particular human-sensor system has a network of 30 sensors but only 20 available monitors, then the feeds from 10 of the sensors are necessarily obscured at any given time. The obscured sensors may have critical data that would not be accessible to an observer. Moreover, in order to select which of the available sensor feeds is currently displayed on a particular monitor, an observer is typically required to use a keypad to enter a numeric value representing a desired sensor and another numeric value representing a desired monitor for displaying the sensor feed. This highly deliberative operation requires prior knowledge of the desired sensor's numeric identifier, or the use of an external aid, such as a map, to determine the proper identifier.

Lastly, transferring observer control across available sensors presents significant challenges in the framework of existing human-sensor systems. That is, an observer must be provided with a means for identifying and selecting a sensor of interest for direct control. Typically, this is accomplished in a manner similar to the display selection process described above, such as by an observer entering a numeric identifier corresponding to a sensor of interest into a keypad, at which point a joystick or other control device being used is assigned control over the selected sensor. As with display selection, the observer must either have prior knowledge of the identifier for the desired sensor or must consult an external aid. Furthermore, the feed from the desired sensor must generally be displayed before the sensor can be selected for control. Thus, if the feed from the sensor of interest is not currently being displayed on a monitor, the feed must first be selected for display (as described above), and then selected for control. This can be an extremely time-consuming process.

In view of the foregoing, it is an object and feature of the present invention to provide a human-sensor system having a physical control device that provides a highly intuitive, unambiguous control mapping between the control device and a sensor that is being controlled by the control device.

It is a further object and feature of the present invention to provide a human-sensor system having a control device that independently provides an observer with an indication of the current orientation of a sensor being controlled by the control device.

It is a further object and feature of the present invention to provide a human-sensor system having a display component that allows an observer to anticipate the result of a change in view direction by displaying the currently viewed scene within the context of the scene's surrounding environment.

It is a further object and feature of the present invention to provide a human-sensor system having a display component that allows an observer to easily and accurately determine the spatial relationships between the sensors in the system.

It is a further object and feature of the present invention to provide a human-sensor system having a display component that allows an observer to simultaneously view data feeds from substantially all of the sensors in the system.

It is a further object and feature of the present invention to provide a human-sensor system that allows an observer to identify and select a particular sensor of interest to control without requiring the use of an external aid or prior knowledge of an identifier associated with the sensor.

### BRIEF SUMMARY OF THE INVENTION

In accordance with the objectives of the present invention, there is provided an improved human-sensor system for allowing an observer to perceive, navigate, and control a sensor network in a highly efficient and intuitive manner. The inventive system is defined by several layers of hardware and software that facilitate direct observer control of sensors, contextual displays of sensor feeds, virtual representations of the sensor network, and movement through the sensor network.

A first layer of the inventive human-sensor system is a user control device that preferably includes a control arm pivotably mounted to a pedestal at a fixed point of rotation. The orientation of the control arm can be manipulated by a human user, and an orientation sensor is mounted to the control arm for measuring the orientation of the control arm relative to the fixed point of rotation. The orientation data is communicated to a computer that is operatively linked to a remotely-located sensor, such as a surveillance camera. The computer instructs the remotely-located sensor to mimic the measured orientation of the control arm. By moving the control arm, the user can thereby cause the remotely-located sensor to move in a like manner. For example, if the user orients the control arm to point east and 45 degrees down from horizontal, the remotely-located sensor will move to point east and 45 degrees down from horizontal. The control device thereby continuously informs the user of the absolute orientation of the remotely located sensor.

A second layer of the inventive human-sensor system provides an observer with an enhanced, contextual view of the data feed from a sensor. This is accomplished through the implementation of software that receives the data feed from a sensor and that uses the data to create a virtual, panoramic view representing the viewable range of the sensor. That is, the software “paints” the virtual panorama with the sensor feed as the sensor moves about its viewable range. The virtual panorama is then textured onto an appropriate virtual surface, such as a hemisphere. An observer is then provided with a view (such as on a conventional computer monitor) of the textured, virtual surface from a point of observation in virtual space that corresponds to the physical location of the sensor in the real world relative to the scene being observed. The provided view includes a continuously-updated live region, representing the currently captured feed from the remotely-located sensor, as well as “semi-static” region that surrounds the live region, representing the previously captured environment that surrounds the currently captured environment of the live region. The semi-static region is updated at a slower temporal scale than the live region. The live region of the display is preferably highlighted to aid an observer in distinguishing the live region from the semi-static region.

A third layer of the inventive human-sensor system enables an observer to switch from the first-person view perspective described in Layer 2, wherein the observer was able to look out from the position of the sensor onto the textured virtual display medium, to a third-person view perspective, wherein the observer is able to view the display medium from a movable, virtual point of observation that is external to the virtual location of the sensor. Specifically, the observer is able to controllably move to a point of observation located on a “perspective sphere” that is centered on the virtual location of the sensor and that surrounds the virtual display medium. The observer controls the position of the point of observation on the perspective sphere by manipulating the control interface described in layer 1. The observer is thereby able to “fly above” the virtual display medium in virtual space and view the display medium from any vantage point of the perspective sphere. Switching between the first person-perspective of Layer 2 and the third-person perspective of Layer 3 is preferably effectuated by rotating a second orientation sensor that is rotatably mounted to the control arm of the control interface.

A fourth layer of the inventive human-sensor system implements a complete, virtual representation of the entire sensor network wherein each sensor is represented by a textured, virtual display medium similar to the display medium described in Layer 2. The relative locations of the sensor representations within the virtual space correspond to the physical locations of the sensors in the real world. For example, if two sensors are located in adjacent rooms within an office building in the physical world, two virtual display mediums (e.g., two textured, virtual hemispheres) will appear adjacent one another in the 3-dimensional, virtual network space. Similarly, if one sensor in the physical sensor network is elevated relative to another sensor in the network, the disparity in elevation will be preserved and displayed in the virtual network space. An observer is provided with a view of the virtual network from a movable, virtual point of observation in the virtual network space. The configuration of the entire sensor network, including areas that are not covered by the network, is therefore immediately perceivable to an observer viewing the virtual network space by moving the point of observation.

A fifth layer of the inventive human-sensor system provides a methodology for moving between and controlling the sensors in the virtual sensor network of Layer 4 described above. As a first matter, an observer is able to move the virtual point of observation through the virtual network space, and thereby visually navigate the space, by manipulating the control interface of Layer 1. The control interface is provided with an additional “translational capability” wherein a first segment of the control arm is axially slidable relative to a second segment of the control arm. A slide potentiometer measures the contraction and extension of the arm and outputs the measured value to the sensor system's control software. The observer can thereby use the control interface to move the virtual point of observation nearer or further from objects of interest within the virtual network space by sliding the control arm in and out, and is also able to rotate about a fixed point of rotation within the virtual network space by manually pivoting the control arm relative to the pedestal as described in Layer 1. The controller provides a convenient means for allowing an observer to navigate to any point in the virtual network space of Layer 4.

Each of the sensor representations in the virtual network space is provided with an invisible, spherical “control boundary” that encompasses the sensor representation. In order to assume direct control of a particular physical sensor within the sensor network, an observer simply navigates the virtual point of observation into the control boundary of that sensor. Upon crossing from the outside to the inside of the control boundary, the observer's fixed point of rotation switches to the virtual location of the selected sensor within the network space and the selected sensor begins to movably mimic the orientation of the control interface as described in Layer 1. The observer is thereby able to control the view direction of the sensor and is able to view the live feed of the sensor on the textured virtual display medium of the sensor. To “detach” from the sensor and move back into virtual space, the observer simply manipulates the control interface to move the point of observation back out of the sensor's control boundary, and the observer is once again able to navigate through the virtual network space and supervise the sensor network.

### BRIEF DESCRIPTION OF THE SEVERAL VIEWS OF THE DRAWINGS

FIG. 1 is a perspective view illustrating the perspective controller of the present invention and remotely-located surveillance camera that is operatively linked to the perspective controller.

FIG. 2 is a side view illustrating the perspective controller of the present invention and the remotely-located surveillance camera shown in FIG. 1.

FIG. 3 is a plan view illustrating the perspective controller of the present invention and the remotely-located surveillance camera shown in FIG. 1 as taken along view line 3-3 in FIG. 2.

FIG. 4a is a front view illustrating a computer monitor displaying a contextually enhanced sensor feed from a video surveillance camera.

FIG. 4b is a front view illustrating the computer monitor shown in FIG. 4a wherein the surveillance camera has been panned to the left.

FIG. 4c is a front view illustrating the computer monitor shown in FIG. 4b wherein the surveillance camera has been panned further to the left.

FIG. 5a is a front view illustrating a computer monitor displaying a contextually enhanced sensor feed from a video surveillance camera.

FIG. 5b is a front view illustrating the computer monitor shown in FIG. 5a wherein an individual in the field of view of the surveillance camera has moved to the left.

FIG. 5c is a front view illustrating the computer monitor shown in FIG. 5b wherein the individual in the field of view of the surveillance camera has moved further to the left.

FIG. 6a is a perspective view illustrating a perspective sphere of the present invention.

FIG. 6b is a perspective view illustrating the perspective controller of the present invention and a computer monitor displaying a view from a virtual point of observation located on a perspective sphere.

FIG. 6c is a perspective view illustrating the perspective controller and computer monitor shown in FIG. 6b wherein the control arm of the perspective controller has been oriented to point straight down and the view displayed on the monitor has changed to provide a corresponding view from the perspective sphere.

FIG. 6d is a perspective view illustrating the perspective controller and computer monitor shown in FIG. 6c wherein the control arm of the perspective controller has been contracted and the view displayed on the monitor has changed to provide a corresponding view from the shrunken perspective sphere.

FIG. 7a is a perspective view illustrating the perspective controller of the present invention and a computer monitor displaying a view from a virtual point of observation located in a virtual network space.

FIG. 7b is a perspective view illustrating the perspective controller and computer monitor shown in FIG. 7a wherein the control arm of the perspective controller has been contracted and the view displayed on the monitor has changed to provide a narrower view of a sensor representation of interest.

FIG. 7c is a perspective view illustrating the perspective controller and computer monitor shown in FIG. 7b wherein the control arm of the perspective controller has been contracted and the view displayed on the monitor has narrowed to reflect that the sensor of interest has been selected for control.

FIG. 7d is a perspective view illustrating the perspective controller and computer monitor shown in FIG. 7c wherein the control arm of the perspective controller has been extended and the view displayed on the monitor has widened to reflect that the sensor of interest has been deselected.

FIG. 7e is a perspective view illustrating the perspective controller and computer monitor shown in FIG. 7d wherein the control arm of the perspective controller is being rotated and the view displayed on the monitor is shifting accordingly.

FIG. 7f is a perspective view illustrating the perspective controller and computer monitor shown in FIG. 7e wherein the control arm of the perspective controller has been rotated and the view displayed on the monitor has shifted to reflect that a new sensor of interest has been identified.

FIG. 7g is a perspective view illustrating the perspective controller and computer monitor shown in FIG. 7f wherein the control arm of the perspective controller has been contracted and the view displayed on the monitor has narrowed to reflect that the new sensor of interest has been selected for control.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

Fundamentally, the range of possible views from any fixed point in space is a sphere. Human visual perception therefore operates within a moving spherical coordinate system wherein a person's current field of view corresponds to a segment of a visual sphere that surrounds the person at all times. The devices and methods of the present invention exploit the parameters of this spherical coordinate system to provide a human-sensor system that is both naturally intuitive and highly efficient. The inventive human-sensor system facilitates exploration of distant environments in a manner that is driven by an observer's interest in the environments, instead of by slow, deliberative, cognitive reasoning that is typically required for operating and perceiving traditional human-sensor systems.

The benefits of the inventive human-sensor system are realized through the implementation of several components, or “layers,” of integrated hardware and software. These layers include a user control interface; a virtual display medium; a movable, virtual point of observation; a virtual sensor network; and a methodology for navigating and selectively controlling sensors within the virtual sensor network. Some of these layers, such as the user control interface, can be implemented independently of the rest of the system, while other layers are only useful in the context of the entire integrated sensor system. Several of the layers implement software-based, virtual structures and environments (described in greater detail below). These virtual components are created using Java3d and Java Media Framework. However, it is contemplated that numerous other software packages can alternatively be used for implementing the described components without departing from the spirit of the invention. Each layer of the inventive human-sensor system will now be discussed in-turn.

Layer 1: The Perspective Controller

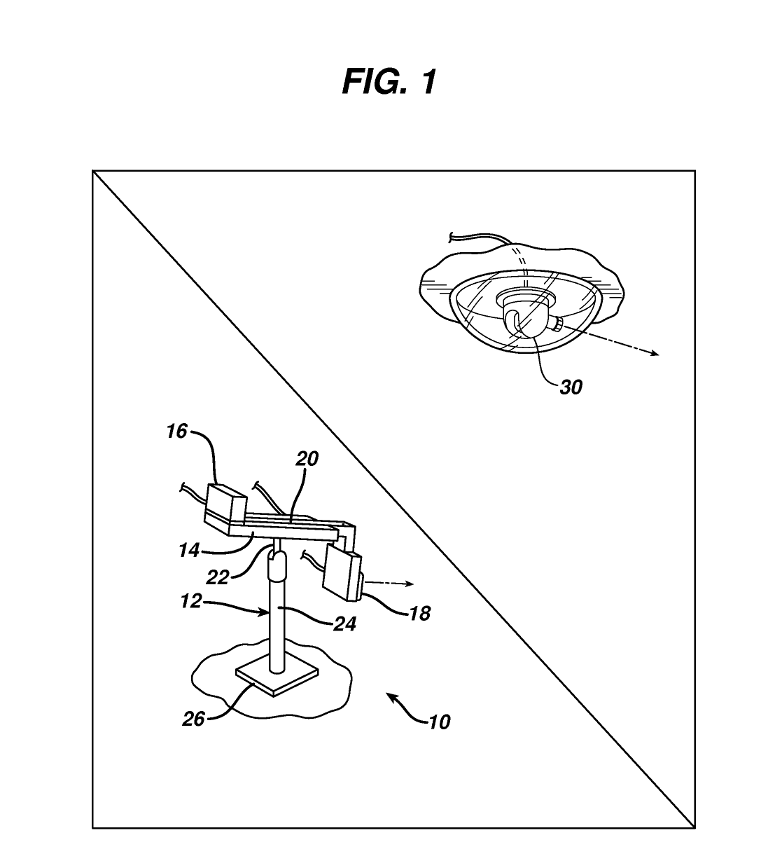

Referring to FIG. 1, a user control interface 10, hereafter referred to as the “perspective controller,” is shown. The perspective controller 10 includes a vertically-oriented pedestal 12, a translating control arm 14, a first orientation sensor 16 rigidly mounted to the control arm 14, a second orientation sensor 18 rotatably mounted to the control arm 14, and a slide potentiometer 20 embedded within the control arm 14. The control arm 14 is hingedly mounted to a stem 22 for allowing the control arm 14 to be tilted along a vertical plane relative to the stem 22. The stem 22 is rotatably mounted to the shaft 24 of the pedestal 12 for allowing the control arm 14 and the stem 22 to be rotated about the vertical axis of the pedestal 12. Frictional engagement between the control arm 14 and the stem 22 and between the stem 22 and the shaft 24 of the pedestal 12 is sufficiently weak for allowing a human user to easily tilt and rotate the control arm 14 with one hand, but is sufficiently strong for maintaining the position of the control arm 14 when it is not being manipulated. The base 26 of the pedestal 12 is of a sufficient size and weight for securely maintaining the position of the perspective controller 10 on a flat surface while the control arm 14 is manipulated by a user. Alternatively it is contemplated that the pedestal 12 can be rigidly mounted to a surface for securing the controller 10 in a like manner.

In its most basic capacity, the perspective controller 10 serves as a substitute for a joystick or other conventional control device in a traditional human-sensor system. When the controller 10 is used thusly, the rotatably mounted orientation sensor 18, the slide potentiometer 20, and the translational capability of the control arm 14 can be disregarded, as they will not be used. A detailed description of these components will be resumed below, as additional layers of functionality are added to the inventive system. For now, only the pedestal 12, the pivotably mounted control arm 14, and the rigidly mounted orientation sensor 16 will be described in detail.

The perspective controller 10 mechanically defines a spherical coordinate system, which constrains any generic point of observation in 3-dimensional space. More particularly, the perspective controller 10 emulates the range of motion of a sensor, such as a PTZ camera, which is one instance of a generic point of observation. For example, a conventional, roof-mounted PTZ surveillance camera can pan 360 degrees about a vertical axis and can tilt roughly 180 degrees about a horizontal axis. Tilting beyond 180 degrees up or down is generally not permitted, as such a range of motion would produce an inverted, non-upright view of the world, which can be disorienting and is therefore undesirable. Accordingly, the control arm of the perspective controller can be rotated 360 degrees about the vertical axis of the pedestal, and can be tilted roughly 180 degrees relative to the pedestal.

The orientation sensor 16 continuously measures the absolute orientation of the control arm 14 and communicates the captured orientation data to a computer (not shown). During testing of the perspective controller 10, an orientation sensor that was found to work well in the context of the present invention was the Xsens MTi from Xsens Motion Technologies, which communicates data and receives power via a universal serial bus (USB) connection. It is contemplated that various other types of orientation sensors can be substituted for this unit. It is further contemplated that various other means for capturing the orientation of the control arm 14 can alternatively be used, such as through the use of conventional step motors, as will be understood by those skilled in the art.

Controller software running on the computer acts as an intermediary between the perspective controller 10 and a remotely-located sensor, such as the video surveillance camera 30 shown in FIG. 1, that is being controlled by the controller 10. The computer is operatively linked to the surveillance camera 30 through a secure local area network (LAN), although it is contemplated that the computer can be linked to the camera 30 in any other conventional manner, including various wired and wireless data communication means. The video feed from the surveillance camera 30, which is also communicated through the secure LAN, is displayed to the operator of the perspective controller on a monitor (not shown).

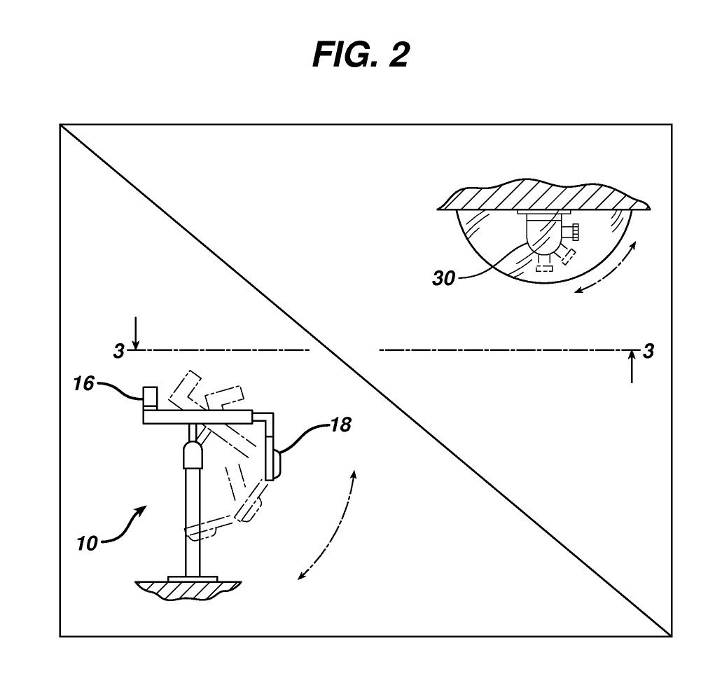

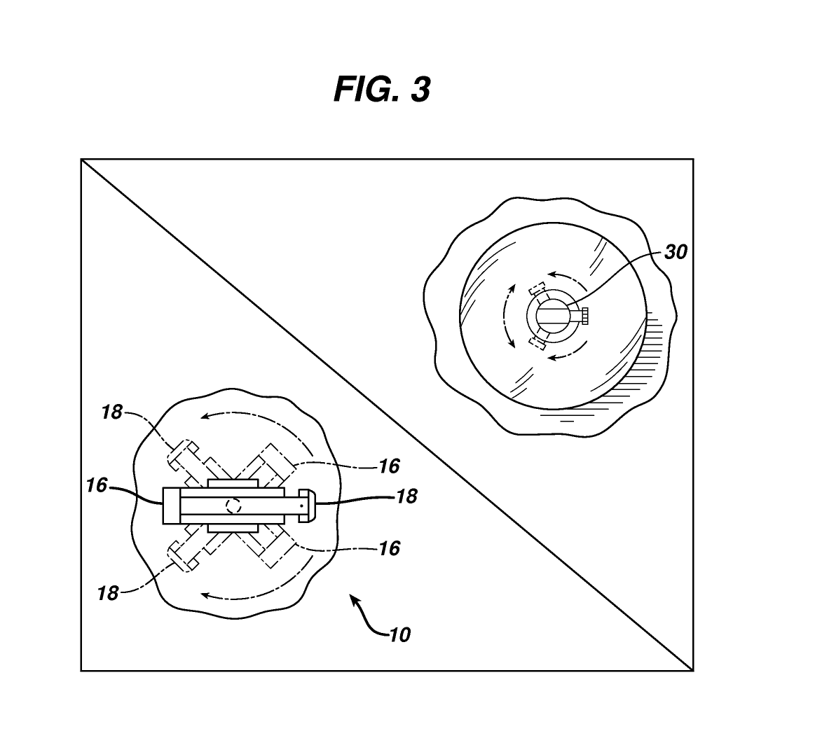

The controller software takes as input the orientation data provided to the computer by the orientation sensor 16. As output, the controller software instructs the remotely-located surveillance camera 30 to orient itself in the same manner as the control arm 14 (i.e., according to the continuously updated data from the orientation sensor 16). For example, referring to FIG. 1, if the control arm 14 of the perspective controller 10 is pointing north and 20 degrees down from horizontal, the camera 30 will be instructed to point north and 20 degrees down from horizontal as shown. The orientation of the control arm 14 and the surveillance camera 30 are thereby continuously synchronized as depicted in FIGS. 2 and 3. The perspective controller 10 therefore always provides independent visual feedback relating to the view direction of the video camera 30. By observing that the control arm 14 is pointing southeast and 20 degrees down from horizontal, for example, an individual immediately knows that the remotely-located camera 30 is oriented in a similar fashion.

In current approaches known to the inventor, the only source of information for determining the orientation of a camera is through the video feed itself. This information must be extracted deliberately from the video and, if an observer is unfamiliar with the environment shown in the video, is of limited usefulness. The perspective controller 10 overcomes this deficiency by providing constant perceptual feedback with regard to the current view direction of the camera, as well as all other view directions that are available. That is, the perspective controller 10 shows an observer where the camera is pointing now, where it is not pointing, and all the locations it could point next. This is observable independent of any video feed. An observer is therefore not only able to quickly and easily determine the current view direction of the camera, but is also able to intuitively anticipate changes in view direction. For example, if the perspective controller 10 is pointing to the east, an observer can predict that rotating the control arm 14 90 degrees to the right will result in the camera's view direction pointing south. This is in direct contrast to traditional control interfaces, which require an observer to rely exclusively on the change in the visual field of the controlled viewpoint to determine an amount of rotation.

Regarding the specific construction of the perspective controller 10 described above, it is contemplated that any suitable, alternative mechanical embodiment can be incorporated that defines a view direction with respect to a fixed point of rotation. Most basically, the perspective controller is composed of a fixed point of rotation and a view direction, wherein the fixed point of rotation defines the center of a sphere and the view direction is positioned on the sphere. The orientation of the view direction with respect to the fixed point of rotation defines two separate controller configurations (described in greater detail below). When the view direction is pointed outward away from the fixed point of rotation the controller is in the inside-out configuration. When the view direction is pointed inward toward the fixed point of rotation the controller is in the outside-in configuration. The importance of these configurations will become apparent in the description of subsequent layers of the sensor system.

Any mechanical embodiment satisfying these constraints with proper sensing will allow a user to manually specify a pan and tilt orientation. The embodiment will thus make the orientation of the sensor visually apparent to an observer. For example, an embodiment of the perspective controller is contemplated wherein a three degree-of-freedom string potentiometer defines the spherical coordinate system (2 rotation and a radius). Orienting the end of the string indicates a position on the sphere and pulling the string in and out indicates the change in radius. The view direction could be implemented with a fourth rotary potentiometer or button to indicate direction.

A physical or mechanical connection between the fixed point of rotation and the view direction is not required. For example, utilizing a hand held video imaging device with video screen and a reference object in the world the same relationships can be instantiated. For the inside-out configuration, accelerometers to measure gravity and a compass to measure orientation provide the inside-out configuration. In order to create the outside-in configuration, however, a method of defining a fixed point of rotation is necessary. One method would use a video imaging device in conjunction with image processing software to identify the reference object in the world. This object serves as the fixed point of rotation for the spherical coordinate system. As the video imaging device is moved, the change in view of in the object dictates the position of the video imaging device in a spherical coordinate system. Movement away is captured by moving the video imaging device away from the object (with a corresponding shrinking of the reference object) and movement towards is captured by moving the video imaging device toward the object (with a corresponding increase in size of the reference object). The view direction is defined by the video imaging devices orientation in the world. The view configuration (inside-out or outside-in) would be specified by the visibility of the reference object in the world. The absence of the reference object would specify the inside-out configuration. It is further contemplated that small motors or friction brakes can be integrated into the construction of the perspective controller 10 for providing resistive feedback when an observer reaches the boundaries of a controlled sensor's viewable range. For example, in the case of the ceiling-mounted camera 30 shown in FIG. 1, the upper vertical boundary of the camera's viewable range is approximately 0 degrees horizontal. That is, the camera 30 cannot look above the ceiling to which it is mounted. Accordingly, digitally-controlled electric motors on the perspective controller 10 can be programmed to prevent, or at least resist, upward vertical movement of the control arm 14 when an observer attempts to orient the control arm 14 above horizontal.

Layer 2: Providing the Sensor Feed with Virtual Context

In traditional human-sensor systems, the only sensor data that is presented to an observer is the current data feed from a particular sensor that is being monitored. For example, in the case of a video surveillance camera, the only sensor data presented to an observer is the current video feed from the camera. This video feed represents a portion of the environment surrounding the camera that is currently within the camera's field of view (typically about 50 degrees×37 degrees). If the surveillance camera is mounted to a ceiling in a room, for instance, an observer of the video feed is presented with only a small segment of the camera's entire hemispheric viewable range (i.e., 90 degrees down from horizontal and 360 degrees about a vertical axis) at any given time. The feed does not provide the observer with any feedback indicating the constraints of the camera's viewable range. Also, by maintaining and displaying only the currently captured image data, all prior image data is lost. The result is an overall loss of context and an inability to perceive which portions of the camera's viewable range have and have not been captured aside from the current field of view.

To establish context, a second layer of the inventive human-sensor system enhances an observer's perception of a data feed that is streamed from a remotely-located sensor through the implementation of a software-based, virtual display medium. This virtual medium provides environmental context to the data feed when the feed is displayed to an observer. In describing a virtual medium for a single sensor, a conventional pan and tilt video surveillance camera will be used as an example. For surveillance purposes, video cameras are typically mounted to ceilings within buildings and outdoors on the rooftops of buildings to provide large viewable areas. The useful range of orientations for such a camera is therefore a downward-pointing hemisphere. That is, the camera is able to pan 360 degrees, but has a limited tilt range spanning from the horizon (0 degrees) to straight down (−90 degrees).

In creating a computer-generated, virtual display medium, the hemispheric viewable range of the described surveillance camera is utilized as a base unit. Particularly, controller software running on a computer that receives the video feed from the surveillance camera (as described above) creates a virtual, downward-pointing hemisphere that corresponds to the viewable range of the camera. This virtual hemisphere serves as a canvas on which the video feed from the camera is painted, with the position of the most currently captured video data corresponding to the current orientation of the video camera in the real world. For example, if the physical video camera is pointed directly downward, the captured video feed will appear on the bottom interior of the virtual hemisphere. This requires mapping each image that is captured by the video camera into a corresponding position within a virtual panorama based on the pan and tilt position of the camera. An algorithm developed by Sankaranarayanan and Davis (2008) achieves this by transforming each pixel position in a captured image into a corresponding pixel position in a virtual panorama. The 2-dimensional panorama is then converted into a texture that is applied to the interior surface of the 3-dimensional, virtual hemisphere in a conventional manner that is well-known to those skilled in the art.

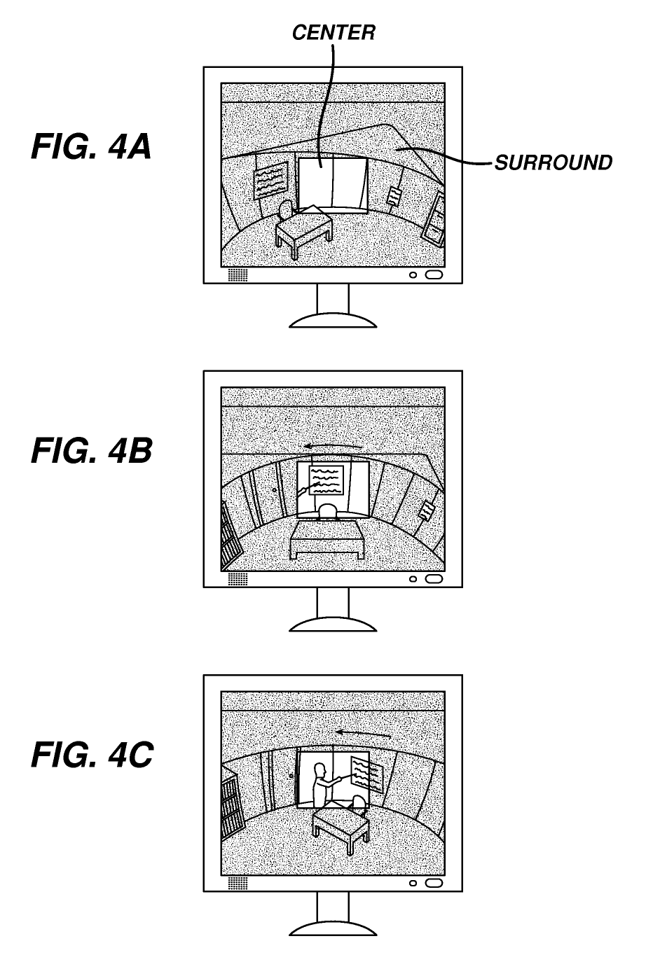

Referring to FIG. 4a, the resulting virtual view that is produced by the controller software and presented to an observer on a monitor is a dynamic combination of two different, interdependent, spatial and temporal regions. The first region, referred to as the “center,” is located in the center of the virtual view and is temporally composed of the most recent video camera data (i.e., a live video feed representing the camera's current field of view). The second region, labeled the “surround,” borders the center within the virtual view and is composed of static views previously captured by the camera that provide an accurate visual representation of the environment surrounding the live video in the center of the view. The combination of the center and the surround creates a virtual panoramic view of the environment of interest having a wider viewable field than the field-of-view of the video surveillance camera in isolation. Referring to FIGS. 4b and 4c, as an observer moves the view direction of the surveillance camera, such as by manipulating the perspective controller described above, the image data reveals the environment in the direction of movement and the image data hides the environment in the direction opposite movement. Particularly, a person in the observed room who was not present when the surround was previously captured is revealed by the live feed as the “center” passes over the area now occupied by the person. It is important to note that in contrast to traditional display means the observer is revealing and obscuring the surround by manipulating the view direction, and not by controlling the relative orientation of a camera. At all times, regardless of the movement of the controller, the position of the live video feed (i.e., the center) is maintained in the center of the panoramic view displayed to the observer.

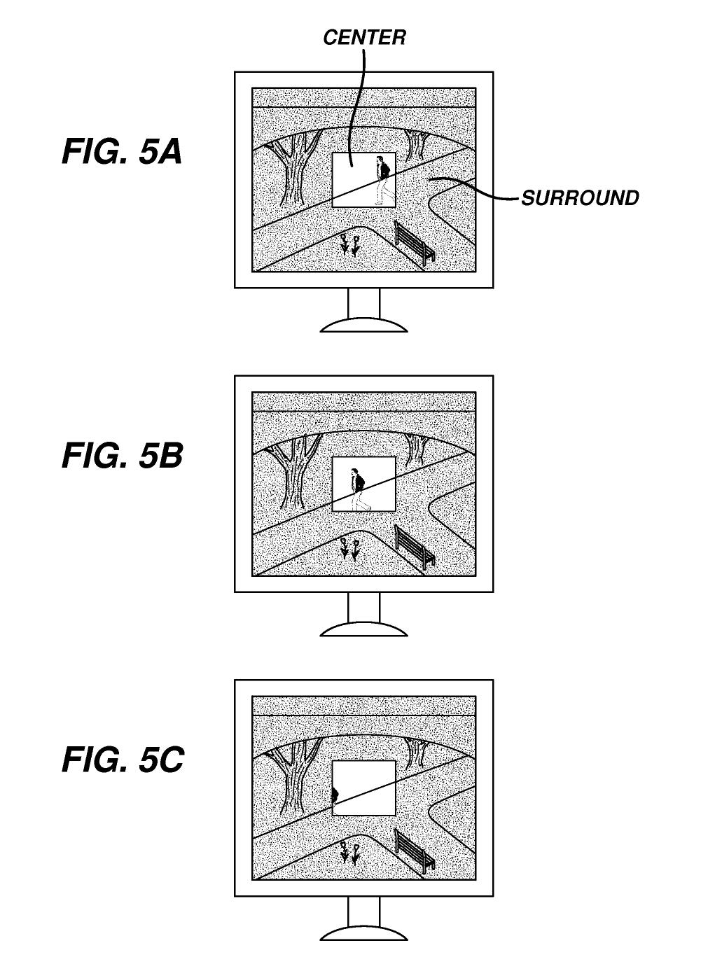

Another example of the described panoramic view is illustrated in FIG. 5a, wherein a park is the environment of interest. Given a particular view direction, a panoramic view of a corresponding portion of the park is displayed on the monitor. Recall that this entire view is not live. The video camera does not see its complete hemispheric viewable range at one time, but enables the controller software to build and update a virtual representation of the hemispheric range using the camera's live video feed. In the center of the displayed view is a region that shows the live video data from the video camera. This portion of the panorama is constantly being updated with the most current video feed. Surrounding this live video feed are views into the park that are not currently being taken with the camera, but that are a trace from the last time the video camera captured that view.

To further demonstrate the relationship between the center and the surround regions, a person is shown walking on the pathway through the park in FIG. 5a. Since the pathway does not change over time, or only very slowly, this structure is a constant in the surround. As the person walks from the center toward a lateral edge of the display, he eventually reaches the boundary between the live video feed of the center and the “static” view of the surround, as shown in FIG. 5b (“static” is not an entirely accurate descriptor, since it is actually slow temporal update). At this point, even though the pathway continues across the boundary, the person begins to disappear, as shown in FIG. 5c. An observer could have panned the camera to follow the person, but this example highlights the contrast between the live view region and the surround view region. The surround region is “frozen” in time until it is moved back into the center (i.e., within the camera's viewable field). Although the view into the park is composed of these two distinct regions, it does not prevent an observer's eyes from moving seamlessly across the entire displayed area. The observer therefore sees a single, wide view into the park.

In order to allow an observer to easily distinguish the center region from the surround region on a display, the rectangular center region is preferably made to appear relatively bright while the bordering surround region is made to appear relatively dim, as shown in FIGS. 4a-c and 5a-c. It is contemplated that the boundary between the two regions can additionally or alternatively be marked by a digitally-interposed rectangle in the display. Still further it is contemplated that more recently sampled portions of the surround can be made to appear brighter and/or sharper in the display while less recently sampled portions are made to appear dimmer and/or fainter, thereby allowing an observer to discern which views are relatively up-to-date and which are not. Independent of the implemented method, the goal is to provide an observer with a visual contrast between the center region and the surround region.

In comparing the inventive display approach to the live-view-only configuration of traditional human-sensor systems, the panoramic frame of reference of the inventive virtual display medium provides several distinct advantages. Through the center-surround relationship, the panoramic visualization displays the current video feed in the context of the surrounding scene structure. An observer is thus able to re-orient the view direction of the sensor based on surrounding context. As the observer “looks” around an environment of interest, he sees a live view of the environment, as well as nearby, non-live views that could be taken in the future. The sensor visualization thereby provides the current sensor feed with environmental context while making explicit the constraints of the sensor's viewable range.

Layer 3: Enabling A Movable, Virtual Point of Observation

In Layer 2 of the inventive human-sensor system described above, an observer was provided with a view of a hemispheric, virtual display medium representing the viewable range of a sensor. The sensor was thus represented by a fixed point of rotation in a virtual space from which the observer was able to look outwardly. That is, the observer was provided with a first-person perspective as though he was located at the sensor, looking onto the distant environment.

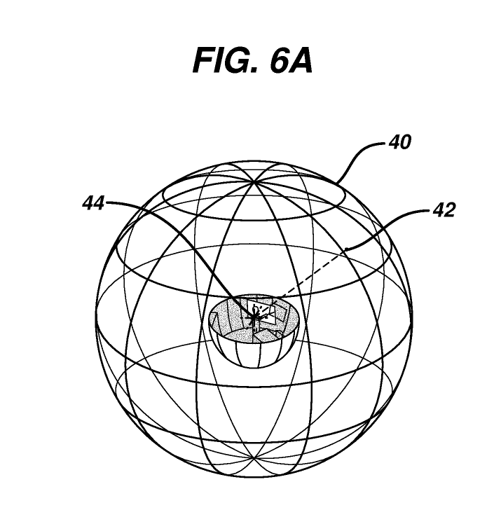

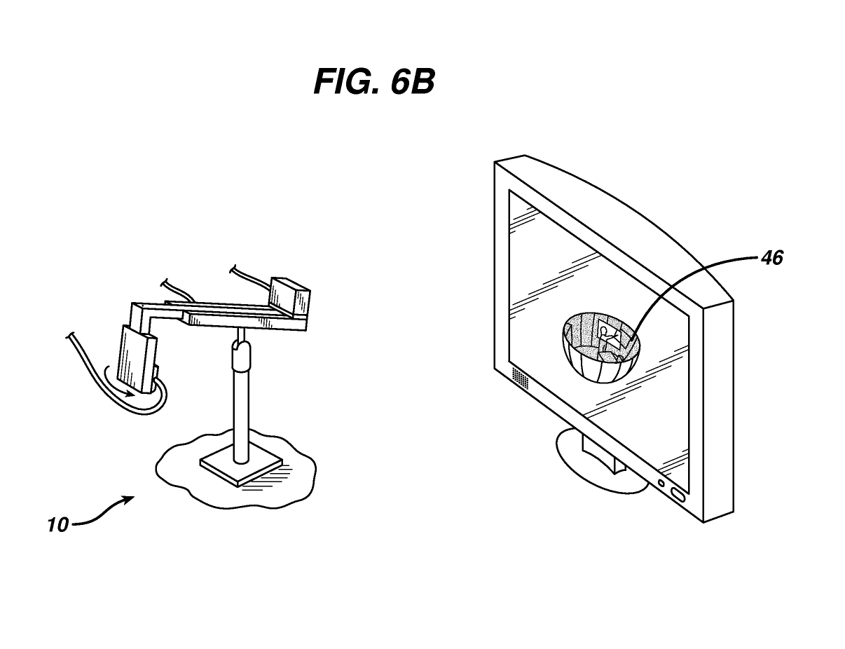

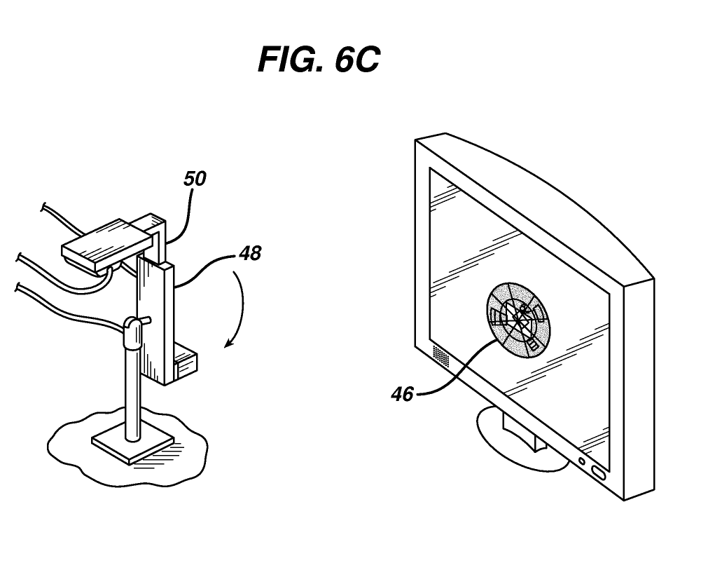

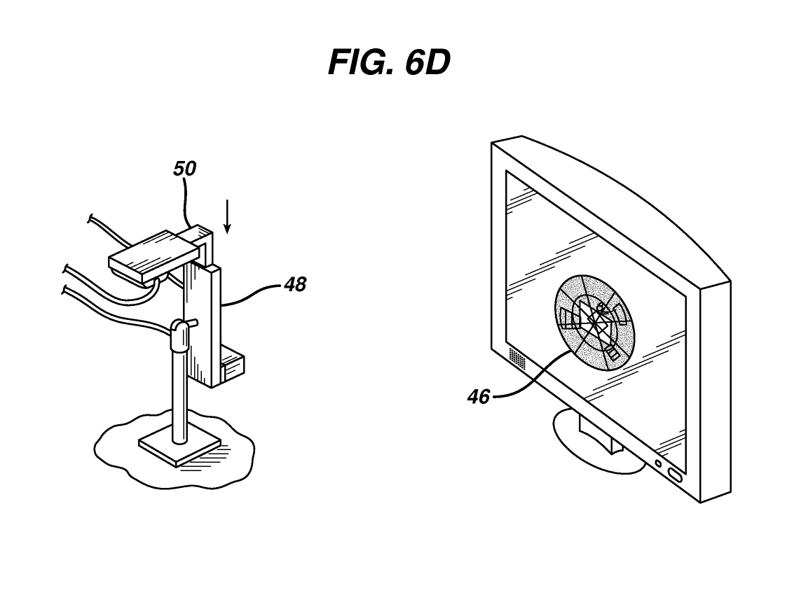

A third layer of the inventive human-sensor system leverages the virtual environment implemented by the controller software in Layer 2 to provide an alternative, third-person view relationship, wherein the virtual point of observation (i.e., the point from which the observer is able to look outwardly) is external to the virtual location of the sensor. That is, the observer is able to switch from an inside-out view, wherein the observer is located at the sensor and is looking out into virtual space, to an outside-in view, wherein the observer is “flying” in the virtual space and is looking back at the sensor. In this outside-in view, the new point of observation is fixed on a virtual sphere 40, referred to as a “perspective sphere” (Roesler and Woods, 2006) and shown in FIG. 6a, with the new view direction oriented inward, from a point of observation 42 on the perspective sphere 40, toward the virtual location of the sensor 44 at the center of the perspective sphere 40. The position of this point of observation 42 is thus external to, but fixed to, the virtual location of the sensor 44. Within the virtual environment, the perspective sphere 40 is centered at the virtual location of the sensor in 44 and encompasses the virtual display medium 46 (e.g., the textured hemisphere described in Layer 2). The observer is thereby able to virtually “fly above” the display medium 46 and view the display medium 46 from any vantage point on the perspective sphere 40. Such a view is shown in the monitor in FIG. 6b. While this is an impossible view relationship for a person to take in the physical world, it can provide very useful vantage points as will be described in greater detail below.

The perspective controller 10, defined in Layer 1 above, is designed to accommodate control of, and switching between, the first-person view relationship defined in Layer 2 and the third-person view relationship described above. Referring back to FIG. 1, the physical control mechanism for switching between the inside-out view direction and the outside-in view direction is the rotatably mounted orientation sensor 18 (described but disregarded in Layer 1) on the control arm 14 of the perspective controller 10. The orientation sensor 18 is fixed to the control arm 14 by a pivot pin (not within view) that transversely intersects the control arm 14. The orientation sensor 18 can be manually rotated 180 degrees about the axis of the pivot pin between a first orientation, wherein the orientation sensor 18 points in the same direction as the rigidly mounted orientation sensor 16 as shown in FIG. 1, and a second orientation, wherein the orientation sensor 18 points in the opposite direction of the rigidly mounted orientation sensor 16 as shown in FIG. 6b. The output from the orientation sensor 18 is constantly communicated to the controller software. When the orientation sensor 18 is in the first orientation, the controller software provides an observer with a first-person perspective of a virtual display medium as provided by Layer 2 of the inventive sensor system. When the orientation sensor 18 is in the second orientation, the controller software provides an observer with the third-person perspective described above, wherein the observer looks from a point on the perspective sphere 40, through the virtual location of the sensor 44 (i.e., the remotely-located sensor, not to be confused with the orientation sensor), at the textured virtual display medium 46.

As described above, the rotatable orientation sensor 18 provides a convenient, intuitive means for switching back and forth between view perspectives because the orientation of the orientation sensor 18 corresponds to an analogous perspective orientation (either in-to-out or out-to-in) in the virtual environment. However, it is contemplated that any other suitable control means, such as a button or a switch mounted on or adjacent the perspective controller, can be implemented for communicating the view configuration of the controller. Fundamentally, this view direction is defined with respect to the fixed point of rotation.

When the third-person perspective relationship is assumed, the perspective controller 10 shown in FIG. 1 conveniently facilitates movement along the perspective sphere 40 shown in FIG. 6a. This is because the perspective controller 10 is a true spherical interface that is capable of identically mirroring the third-person relationship of the perspective sphere 40. Specifically, the controller's mechanical fixed point of rotation (i.e., the juncture of the control arm and the pedestal) represents the fixed point of rotation in the virtual environment (i.e., the virtual location of the sensor 44), and the orientation of the control arm 14 represents the position of the point of observation on the perspective sphere 40. The view direction is pointed inward, towards the center of this perspective sphere 40. Therefore, if an observer wishes to assume a third-person perspective view of the bottom of the hemispheric, virtual display medium described in Layer 2, the observer simply orients the control arm 14 directly upward, as shown in FIG. 6c, with view direction oriented inward towards the center of the perspective sphere 40. As depicted, the resulting view provided to the observer on the monitor is top-down view of the virtual display medium 46. The view provided to the observer is similar to the view provided by Layer 2 described above, but the point of observation is positioned “further back” from the scene of interest in virtual space, thereby allowing an observer to simultaneously view the entire viewable range of the remotely-located sensor (i.e., the entire hemisphere).

The perspective controller 10 also allows the observer to vary the radius of the perspective sphere 40 for moving the observer's point of observation nearer to, or further away from, the virtual display medium. This is achieved through the translating capability of the control arm 14 (briefly described but disregarded in Layer 1). Referring to FIGS. 6c and 6d, the control arm 14 is defined by a first fixed segment 48 and a second translating segment 50. The translating segment 50 fits within the fixed segment 48, and is axially movable along a track (not within view) on the interior of the fixed segment 48 between a fully extended position and a fully contracted position. A slide potentiometer mounted within the fixed segment 48 produces a voltage corresponding to the degree of extension of the translating segment 50 relative to the fixed segment 48 and outputs the voltage to a data acquisition unit (DAQ) (not within view). The DAQ converts the voltage into a digital value which is then communicated to the controller software.

When an observer manually extends the translating segment 50 of the control arm relative to the fixed segment 48, the controller software increases the radius of the perspective sphere and the observer is resultantly provided with a wide view of the virtual display medium 46, as shown in FIG. 6c. That is, the observer's point of observation in the virtual environment is moved further away from the display medium 46. Conversely, when the observer manually contracts the translating segment 50 of the control arm 14 relative to the fixed segment 48, the controller software decreases the radius of the perspective sphere and the observer is resultantly provided with a narrower view of the virtual display medium 46, as shown in FIG. 6d. That is, the observer's point of observation in the virtual environment is moved closer to the display medium 46 in virtual space. This can be thought of as walking toward and away from a painting on a wall in the real world.

When the control arm 14 is in its fully extended position, the perspective sphere is at its maximum radius and the observer is provided with a view of the entire virtual display medium. The exact value of the maximum radius is variable and is preferably determined during configuration of the sensor system. When the control arm 14 is in its fully contracted position, the radius of the perspective sphere is at or near zero, with the point of observation essentially collocated with the virtual location of the camera, and the observer is provided with a view that is nearly identical to the first-person perspective provided by Layer 2. The common element is that the virtual location of the camera serves as the fixed point of rotation in either view configuration within the virtual environment.

Traditional human-sensor systems provide a “what you see is what you get” sensor visualization approach, wherein an observer's visual perception of a distant environment is limited to the current viewable field of a particular sensor of interest. By contrast, the software-based sensor visualization implemented in Layer 3 of the inventive human-sensor system allows an observer to look into a distant environment independent of the current orientation of the remotely-located sensor of interest. No longer must the observer look only where the remote-located sensor is looking.

Layer 4: A Virtual Sensor Network

A fourth layer of the inventive human-sensor system provides an organized, 3-dimensional, virtual space for representing a sensor network. Within the virtual space, the physical relationships between the sensors in the network are readily observable, a moving point of observation is supported, and the methodology for controlling a single sensor as described in the previous layers is preserved. Implementing such a virtual space is a natural extension of the virtual environment provided by Layer 3.

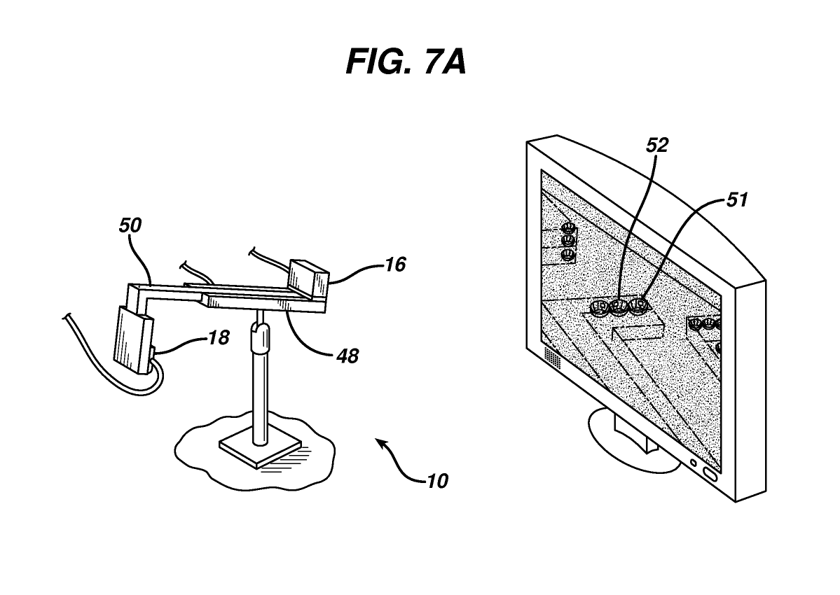

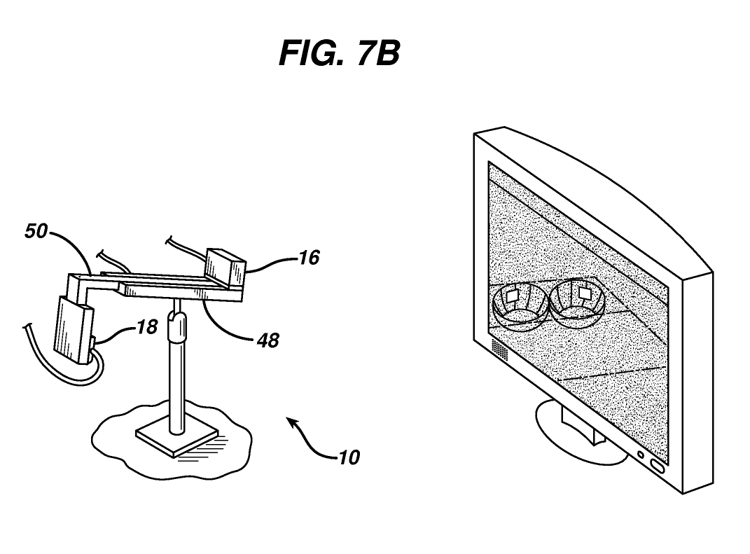

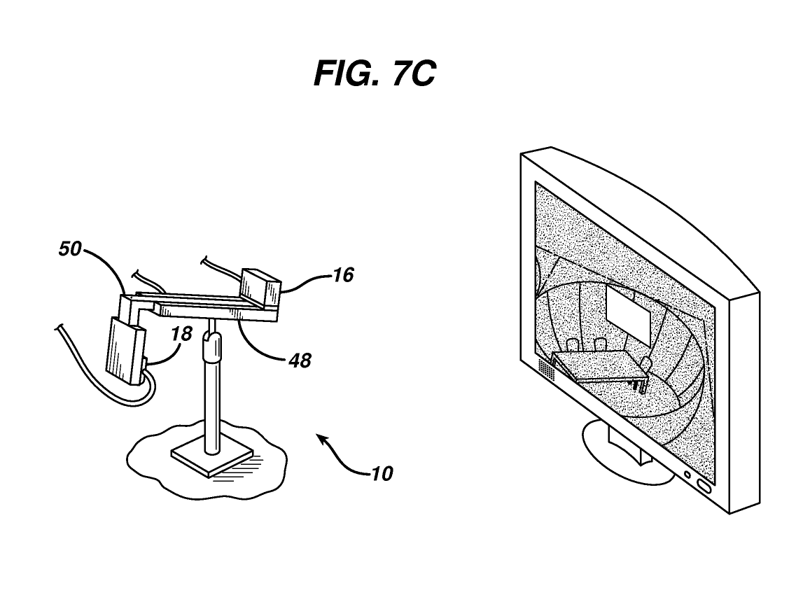

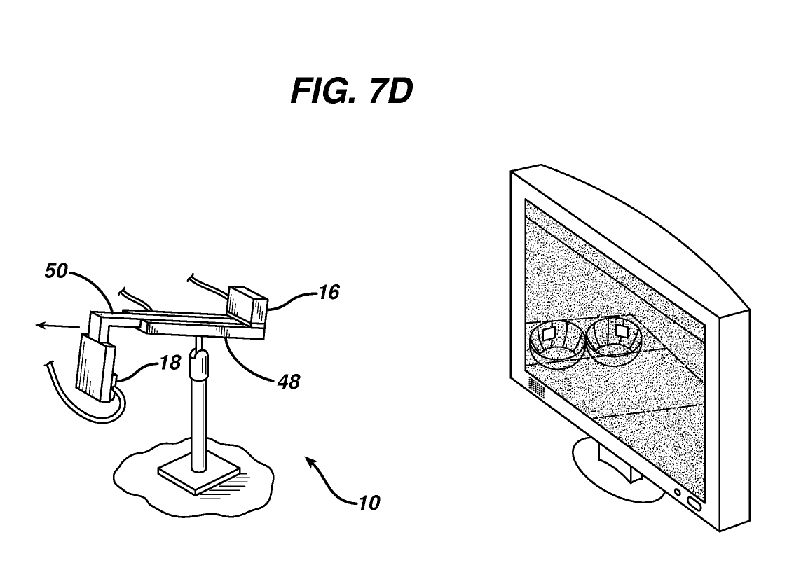

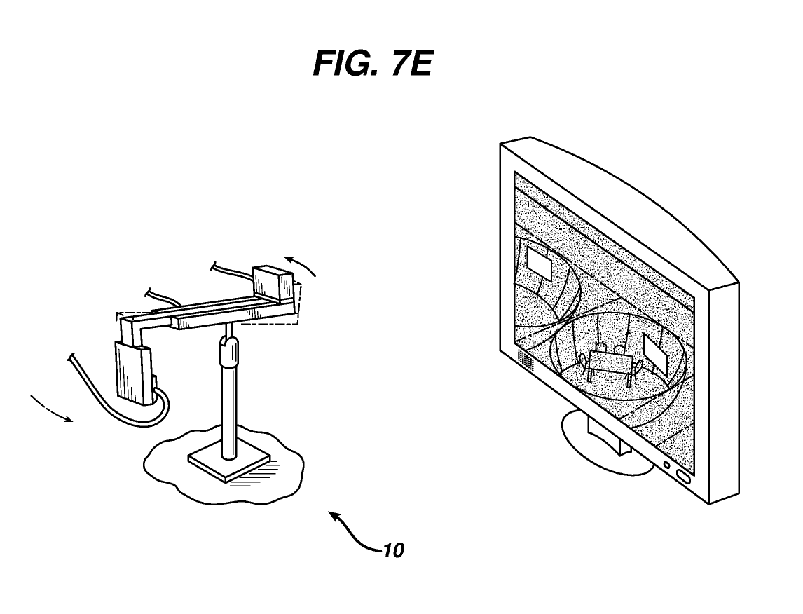

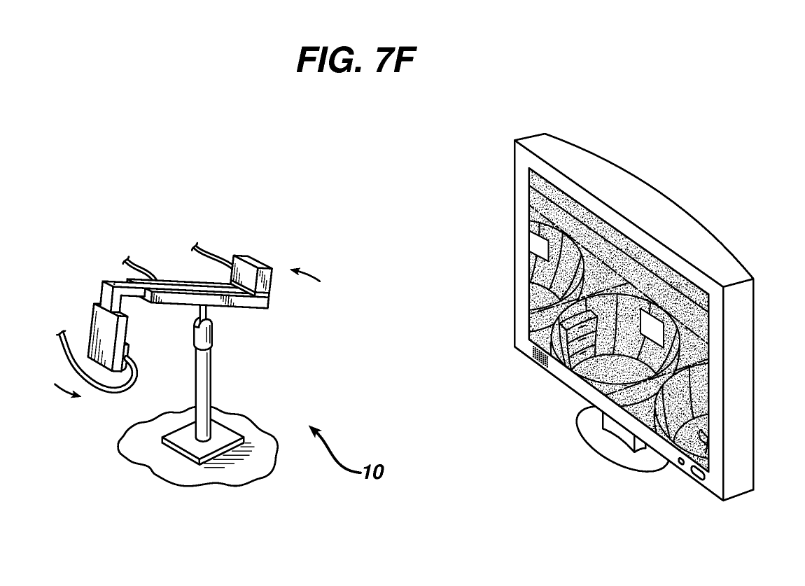

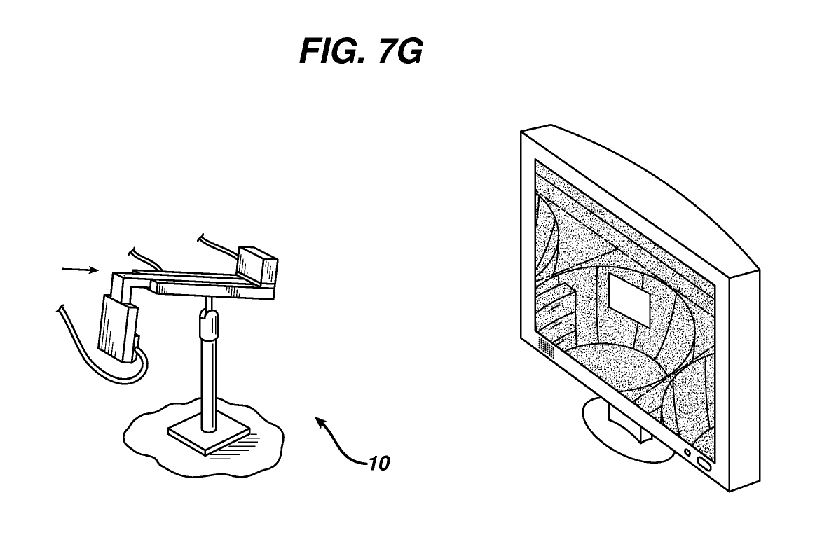

Expanding the virtual, 3-dimensional environment of the preceding layers to include multiple sensors is accomplished by positioning a plurality of sensor representations in the virtual space at unique x, y, and z positions that accurately reflect the locations of the sensors in the real world. For example, if two surveillance cameras in the sensor network are mounted at different elevations in physical space, then two hemispheric, virtual display mediums that correspond to those sensors will be positioned at differing virtual heights within the virtual space. It is also possible for sensor representations to move within the virtual network space, such if the represented sensors are mounted to vehicles or other movable objects in the physical world. These sensor representations are similar to the hemispheric, virtual display medium described in Layer 2. Referring to FIG. 7a, a virtual sensor network is shown that represents three groups of adjacent, remotely-located sensors in three neighboring, physical structures.

Just as before, the 3-dimensional, virtual environment also instantiates a virtual point of observation that provides an observer with a view into the virtual space. The position of this point of observation is controlled with the perspective controller 10 in a manner similar to that described in Layer 3. However, in Layer 3 the fixed point of rotation in the virtual space was a virtual location that corresponded to the physical position of a sensor. In expanding to a sensor network, the fixed point of rotation is now permitted to move within virtual space with no correspondence to a physical location. The result is a 3-dimensional environment populated with a set of sensor representations, one for each physical sensor, and a movable point of observation that provides a controllable view of the spatial layout of the virtual sensor network.

The structure of the inventive virtual sensor network will now be described in detail, with comparisons being made to the “wall of monitors” network display approach of traditional human-sensor systems for the sake of contrast and clarity. Navigation and control of the virtual sensor network will be described below in Layer 5.

Recall that in the “wall of monitors” display approach, the feed from each sensor in a sensor network is displayed on a separate monitor at a central location. If there are more sensors in the network than there are available monitors, then only a subset of the total number of available feeds can be displayed at any one time. The rest of the available feeds are hidden. Common to the “wall of monitors” approach and the inventive, virtual sensor network is the capability to visualize multiple sensor feeds simultaneously. In all other respects, the two approaches differ considerably. The two approaches constrain the views that can be taken in two different manners. In the instance of the “wall of monitors,” there is a predefined, maximum number of sensor feeds that can be displayed at any moment without expanding the number of monitors. Within the display space (i.e., the available monitors), an observer is unable to perceive the extent of the sensor network, the physical areas that the sensors are not currently observing, or the physical areas that lack sensor coverage (i.e., holes in the sensor network). In order to ascertain the extent of the sensor network or the coverage of the currently selected views, an external aid, such as a map, is necessary.

With regard to the inventive, virtual sensor network, there exist an infinite number of viewpoints from which to determine the extent of the network and the available coverage in physical space. The virtual display space can therefore be populated with a theoretically limitless number of sensor representations, all of which are simultaneously viewable within the virtual space from a movable point of observation, along with the current orientations of the sensors and the locations of any holes in the sensor network. Adding or subtracting physical, remotely-located sensors to the network merely requires adding or subtracting virtual sensor representations within the virtual display space. No longer are the currently available views constrained by the number of available monitors.

The traditional and inventive approaches also differ in terms of representing sensor organization. Recall that the “wall of monitors” approach provides no explicit representation of the organization of sensors in a network. That is, the positions of monitors on which sensor feeds are displayed do not explicitly represent any relationships between the sensors in physical space. By contrast, the 3-dimensional, virtual sensor space of the present invention provides an explicit spatial frame-of-reference that reflects the physical positions of the sensors. The lack of such organization in the “wall of monitors” approach means that no immediate interpretation of the display space is possible. The relative positions of sensors within a network must be known a priori or derived from an external source (e.g., a map).

An advantage of spatial organization of the inventive virtual sensor network is the ability to assume virtual viewpoints within the virtual space not possible in the physical space because of physical constraints. Referring to FIG. 7b, for example, an observer is able to “see over a wall” that physically separates two sensors representations 51 and 52. In the physical world, the sensors that correspond to these two hemispheric sensor representations are located in two adjacent rooms in a building that are separated by a common wall and ceiling. There is no position in the physical world that would allow an observer to see into both rooms simultaneously. However, given the virtual space, the virtual display mediums, and the virtual point of observation, an observer is able to ‘see’ into the two rooms simultaneously, as if this view were possible in physical space. That is, as if the ceiling did not exist. The inventor knows of no direct equivalent to this view relationship for the “wall of monitors” approach. While the feeds from two adjacent sensors could be displayed adjacent one another in the display space, determining the adjoining wall would be impossible without several inferences about the relative orientations of the sensors and spatial landmarks.

A second example of available virtual viewpoint, also depicted in FIG. 7b, is the ability to “see nearby sensors.” No privileged or a priori knowledge is required regarding the layout of the sensor network, the number of sensors in the sensor network, or the relationships between sensors in the sensor network. If the sensor feeds are immediately adjacent one another in the virtual space, as are the sensor representations in the middle of the monitor display, it is clear that they are immediately adjacent one another in physical space. In traditional human-sensor systems, there is no such direct method known for seeing the size or layout of a sensor network. If the sensor feed is not currently displayed and there is no external aid identifying all of the available sensors, then there is no method for seeing what other sensor views exist. In addition, with no encoding of spatial relationships between sensors, it is impossible to see what other sensor views are potentially relevant without an external aid.

At this point it is useful to note that in the “wall of monitors” approach an observer is often typically provided with a local map depicting the locations of the sensors in the sensor network. This external aid allows the observer to see the extent of the sensor network, to see holes in the sensor network, to see spatial relationships between views, and to see what other views might be relevant to a given task. However, there is still a deliberative and slow process of transferring the knowledge derived from the map to the display space of the sensor network. In addition, while this method aids an observer in determining the physical locations of sensors within the network, determining and transferring the desired orientations of the sensors from the map is still a highly deliberative, mentally challenging task.

By contrast, the top-down map view is not a separate artifact in the inventive virtual sensor network. Instead, the map view is provided by a specific point of observation in the virtual environment that can be taken at any time. It is the view position from above with the view direction oriented downward (the method for assuming such a perspective in the virtual environment will be described below). This is not a privileged or unique view separate from all others. Instead, it is the view that provides maximum discrimination in the plane of the Earth. If discrimination in that dimension is desired, then this view is ideal. However, if the relevant dimension is the vertical plane (i.e., height of the sensors) a top-down map is less useful. Thus, in the case of the 3-dimensional virtual environment, the top-down view it is simply one of an infinite number of available views. The 3-dimensional environment is actually richer than a 2-dimensional aid such as a map since it is defined in 3-dimensions and supports a moving point of observation. In fact, movement of this virtual point of observation and the corresponding change in the virtual image array is one method for an observer to perceive the 3-dimensional layout of the sensor network.

For the inventive, 3-dimensional virtual environment, the virtual point of observation is restricted to continuous spherical movements through the virtual space (described in greater detail below). Along with the spatial organization described above, this means that virtual movement is also spatially continuous through the virtual sensor network. There is no ability to jump between spatially distributed views. This continuity of views into the sensor network increases the visual momentum of this approach. Supporting visual momentum is one technique for escaping from data overload (Woods, 1984). Given the independence of monitors in display space of the “wall of monitors” approach, visual continuity is not supported. In fact, the available views may be continuous or discontinuous, but assessing the state of a specific configuration of views in the display space is challenging (i.e., consists of mental rotations, use of a priori knowledge, and spatial reasoning). Without continuity there is no sense of visual momentum. One or more views in display space may change and be entirely unrelated to previous and current views. The virtual sensor network of the present invention therefore provides an intuitively superior means for allowing an observer to fully perceive a plurality of remotely-located, physical sensors.

Layer 5: Navigating and Controlling the Virtual Sensor Network

A fifth layer of the inventive human-sensor system utilizes movements of the virtual point of observation within the virtual space (as dictated by manipulation of the perspective controller 10) as a means for navigating the virtual sensor network, for selectively transferring observer control across sensors within the network, and for controlling individual sensors in the network.

As described above and as shown in FIG. 7a, each physical sensor in the sensor network is represented in the virtual network space by a hemispheric, virtual display medium, upon which the sensor's feed is textured. Each virtual display medium occupies a unique location within the virtual network space that corresponds to the physical location of the sensor in the real world and thereby provides a unique, virtual identifier for the sensor. Layer 5 of the inventive system provides each virtual display medium in the virtual space with an invisible, spherical “control boundary” that encompasses the virtual display medium and that is centered on the virtual location of the corresponding sensor. These control boundaries provide an intuitive mechanism for selecting and deselecting a particular sensor for control, as will now be described.

Within the virtual network space, an observer can move the virtual point of observation anywhere he desires by manipulating the control arm 14 of the perspective controller 10. The observer can rotate about a fixed point of rotation in the virtual space by pivoting the control arm 14 of the perspective controller 10 relative to the pedestal 12, and the observer can move nearer or further from an object of interest by sliding the translating segment 50 of the control arm 14 relative to the fixed segment 48 of the control arm 14. By manipulating the perspective controller 10 thusly, the observer can identify a particular sensor of interest in the virtual network (i.e., by orienting the sensor in the center of the display) space and can move the virtual point of observation into that sensor's control boundary (i.e., by slidably contracting the control arm 14), thereby selecting that sensor for control.

When the virtual point of observation moves into the control boundary of the sensor, the controller software switches the perspective controller 10 from controlling only the movement of the virtual point of observation to directly controlling the movements of the selected physical sensor and the virtual point of rotation, simultaneously. That is, panning and tilting the perspective controller 10 will cause the selected physical sensor to pan and tilt in a like manner, as described in Layers 1 and 2 above. If the observer then extends the translating segment 50 of the control arm to move the virtual point of observation outside of all sensor control boundaries, then no sensor is currently selected and the perspective controller 10 is switched back to controlling the movement of the point of observation through the virtual network space. Thus, selecting a sensor for control is accomplished by crossing the sensor's control boundary from outside to inside, and deselecting a sensor is achieved by crossing the sensor's control boundary from inside to outside. The radii of the described control boundaries are predetermined distances that are preferably set during configuration of the inventive sensor system. Any sensors that are not selected for control preferably automatically sweep their respective environments as dictated by a control algorithm in order to continuously remap their corresponding virtual display mediums as described above.

The user experience for selecting or deselecting a sensor is therefore entirely visual, since the method is based on the position of the virtual point of observation. That is, from an observer's perspective visual proximity determines sensor connectivity. If the observer is close enough to a sensor (visually), then the sensor is selected for control. If a sensor appears far away then the sensor is not selected for control. The above-described method for selecting and deselecting sensors within the virtual network space will now be illustrated by way of example.

Referring to FIG. 7a, the view displayed on the monitor is provided by a virtual point of observation that is “floating” in a virtual network space that represents a network of remotely-located surveillance cameras. The control arm 14 of the perspective controller 10 is fully extended and the observer has a wide view of the three groups of adjacent sensor representations in the virtual network. The rightmost sensor representation in the middle group of sensor representations is in the center of the display, and has therefore been identified as the current sensor of interest. In order to select the sensor of interest 51 for control, the observer pushes the translating segment 50 of the control arm forward, as shown in FIG. 7b. On the screen, the observer will see the desired sensor representation grow in size as surrounding structures disappear beyond the screen's edge. Eventually, the control boundary of the desired video camera is reached and crossed, as shown in FIG. 7c. At this point, the observer has taken control of the selected surveillance camera, with the virtual point of rotation now located at center of the sensor representation (i.e., at the virtual location of the camera). The transition is essentially seamless to the observer.

From within the sensor's control boundary, the observer is now looking from the virtual point of observation, through the surveillance camera, at the hemispheric representation of the targeted distant environment. The observer can slide the control arm of the perspective controller to zoom-in still further (not shown), until the virtual point of observation is collocated with the virtual location of the surveillance camera.

Next, referring to FIG. 7d, the observer is pulling back on the control arm of the perspective controller 10, thereby causing the virtual point of observation to move further away from the virtual location of the attached sensor. On the screen, the view of the sensor network grows wider, and the observer sees more of the space surrounding the virtual sensor representation. Eventually, a transition occurs, and the virtual viewpoint crosses the control boundary for the current sensor, at which point the observer is disconnected from the video camera. A second change also occurs that was not previously described. In addition to disconnecting from the sensor, there is a shift in the virtual point of rotation within the virtual space. The justification for this shift requires a brief digression.

As previously described, expressing interest in, and selecting, a particular sensor requires reorienting the observer's view direction toward that sensor (i.e., by moving the sensor into the center of the display). Notice, however, that when connected to a sensor the virtual point of rotation is fixed at the center of the sensor representation (i.e., at the virtual location of the sensor of interest). If the user now pulls away and disconnects from that sensor and wants to select a different sensor, but the virtual point of rotation remains located at the center of the disconnected sensor representation, then any reorientation of the perspective controller will only point towards the same disconnected sensor representation. This is not the desired behavior when disconnected from a sensor. In order to orient to a new sensor, the virtual point of rotation must be external to all sensor representations. This is accomplished through a particular method. When the control boundary of a sensor representation is crossed and the sensor is disconnected from control, the virtual point of rotation is immediately shifted. In order to maintain visual continuity, this new virtual point of rotation is located at the intersection of the sensor's invisible control boundary and the virtual viewpoint. That is, the fixed point of rotation shifts to the point on the spherical control boundary at which the virtual point of observation exited, or “backed out of,” the control boundary. With the virtual point of rotation now located external to the previously-selected sensor representation, the observer can now reorient the view direction to point at another sensor representation. It should be noted at this point that attaching to a sensor (i.e., crossing from the outside to the inside of its control boundary) brings about the opposite action. That is, whenever and wherever a sensor representation control boundary is crossed, indicating a sensor selection, the virtual point of rotation moves to the center of that virtual sensor representation.

Referring back to the example in FIG. 7d, the observer is now disconnected from the previously selected camera and is rotating about a new virtual point of rotation as described above. The observer has extended the control arm 14 of the perspective controller 10 and the entire sensor network is again within view. Referring now to FIG. 7e, the observer uses the perspective controller 10 to reorient the virtual viewpoint about the new virtual point of rotation such that middle sensor representation in the middle group of sensor is moved to the center of the display, as shown in FIG. 7f, thereby identifying a new sensor of interest. In order to select the new sensor of interest for direct control, the observer slides the translating segment 50 of the control arm 14 inward, as shown in FIG. 7g. On the screen, the observer sees the desired sensor representation grow in size as before. Eventually, the control boundary of the desired video camera is reached and crossed, and the observer takes control of the selected sensor as described above. Other methods for selecting and deselecting a sensor are possible. However, they must all provide a mechanism to select and deselect a sensor.

A more complex approach to human-sensor control can also provide intermediate forms of control between selected and not-selected, such as influencing a sensors sampling without direct control. For example, when the observer assumes the third-person view perspective, it is important to note that the remotely-located sensor is no longer under direct control of the perspective controller 10. Instead, the movements of the remotely-located sensor are dictated by a control algorithm that is executed by the controller software. The control algorithm takes as input the current third-person view direction of the observer (as dictated by the orientation of the perspective controller) in order to identify the observer's current area of visual interest within the hemispheric virtual display medium. The algorithm will then instruct the remotely-located sensor to automatically sweep the area of the distant environment that corresponds to the area of interest in the display medium, thereby continually updating the area of interest in the display medium as described in Layer 2. For example, if an observer moves the perspective controller 10 to provide a view of the northeast quadrant of the hemispheric, virtual display medium associated with the surveillance camera described above, the control algorithm will instruct the surveillance camera to sweep the northeast quadrant of its surrounding environment and will use the incoming video feed to continuously update the northeast quadrant of the display medium.

A first contemplated application of the complete human-sensor system described above is a surveillance network for an office building, wherein numerous surveillance cameras are mounted at strategic locations throughout the building. An observer, such as a night watchman, can be positioned within the building or at a remote location external to the building. The watchman is provided with a view of the virtual network on a computer monitor, wherein the watchman can see sensor representations of all of the sensors in the building's surveillance network. The watchman is also provided with a perspective controller for navigating and controlling the sensors in the manner described above. For example, if the watchman wants to observe a particular room in the building, the watchman can use the perspective controller to “fly over” and look into the sensor representation that corresponds to that room in the virtual network space. The watchman can also use the perspective controller to move into the control boundary of the sensor representation and take control of the physical sensor to manually scan the room.

A second contemplated application of the inventive human-sensor system is a command network for a battlefield environment, wherein a variety of different types of sensors are mounted to various mobile and immobile platforms within and surrounding the battlefield, such as tanks, aircraft, and command towers. A commander positioned outside of the battlefield environment is provided with a virtual view of the command network and can navigate and control the network with a perspective controller. For example, the commander may choose to observe the sensor representation of a night vision camera mounted on a tank that is on the front line. Alternatively, the commander may choose to observe a sensor representation displaying a RADAR feed from an aircraft flying over the battle field. In both cases, the sensor representations would be moving through the virtual network space in accordance with movements of the tank and the aircraft through physical space.

The above-described applications of the inventive human-sensor system are provided for the sake of example only and are not any way meant to define a comprehensive list. It will be understood by those skilled in the art that many other applications of the inventive system are contemplated by the inventor.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A spherical control interface for controlling the movements of a remotely-located sensor, the spherical control interface comprising:
a. a fixed point of rotation; and
b. means for orienting a view direction relative to the fixed point of rotation.

2. The spherical control interface in accordance with claim 1, further comprising means for measuring the orientation of the view direction.

3. A spherical control interface for controlling the movements of a remotely-located sensor, the spherical control interface comprising:
a. a control arm pivotably mounted to a fixed point of rotation for allowing a human user to manually manipulate an orientation of the control arm relative to the fixed point of rotation to indicate a view direction; and
b. means for measuring the absolute orientation of the control arm.

4. The spherical control interface in accordance with claim 3, wherein the means for measuring an absolute orientation of the control arm comprises an orientation sensor that is mounted to the control arm.

5. The spherical control interface in accordance with claim 3, wherein the control arm comprises:
a. at least two elongated segment that are slidably connected to each other for allowing the control arm to be extended and contracted; and
b. means for measuring the degree to which the control arm is extended.

6. The spherical control interface in accordance with claim 5, wherein the means for measuring the degree to which the control arm is extended comprises a slide potentiometer.

7. The spherical control interface in accordance with claim 3, further comprising an orientation sensor this is rotatably mounted to the control arm.

8. The spherical control interface in accordance with claim 3, wherein the spherical control interface is operatively linked to the remotely-located sensor and the remotely-located sensor movably mimics the absolute orientation of the control arm as measured by the orientation sensor.

9. The spherical control interface in accordance with claim 3, wherein the measured orientation of the control arm is communicated to a computer that is operatively linked to the remotely-located sensor and the computer instructs the remotely-located sensor to orient itself in the same manner as the control arm.

10. An improved method for viewing sensor data that is captured and communicated by a remotely-located sensor, the improvement comprising:
a. using the sensor data to produce a computer-generated, virtual panorama representing a viewable environment of the remotely-located sensor;
b. texturing the virtual panorama onto a virtual display medium; and
c. providing a view of the textured virtual display medium from a virtual point of observation that preserves a spatial relationship between the remotely-located sensor and viewable environment, wherein a segment of the provided view of virtual display medium represents a live feed from the remotely-located sensor that corresponds to the current orientation of the remotely-located sensor, and the rest of the provided view of the virtual display medium represents previously captured, and yet to be captured, portions of an environment of the remotely-located sensor that surround the portion of the environment shown in the live feed.

11. The improved method for viewing sensor data in accordance with claim 10, wherein the step of texturing the virtual panorama onto a virtual display medium comprises texturing the virtual panorama onto a virtual surface that represents the viewable range of the remotely-located sensor.

12. The improved method for viewing sensor data in accordance with claim 11, wherein the step of texturing the virtual panorama onto a virtual surface that represents the viewable range of the remotely-located sensor comprises texturing the virtual panorama onto the surface of a virtual hemisphere.

13. The improved method for viewing sensor data in accordance with claim 11, further comprising switching between a first-person view perspective of the textured virtual display medium, wherein a point of observation is a location in virtual space that corresponds to the physical location of the remotely-located sensor, and a third-person view perspective of the textured virtual display medium, wherein the point of observation is located on a virtual perspective sphere that is centered on the virtual location of the remotely-located sensor and that surrounds the virtual display medium.

14. The improved method for viewing sensor data in accordance with claim 13, wherein the step of switching between the first-person and third-person view perspectives comprises manipulating a physical switching mechanism.

15. The improved method for viewing sensor data in accordance with claim 13, further comprising controlling the remotely-located sensor with a spherical control interface while in the first-person view perspective.

16. The improved method for viewing sensor data in accordance with claim 13, further comprising controlling the location of the virtual point of observation with a spherical control interface while in the third-person view perspective.

17. An improved method for viewing sensor data that is captured and communicated by a plurality of remotely-located sensors, the improvement comprising:
a. using the sensor data to produce computer-generated, virtual panoramas, wherein each virtual panorama represents a viewable environment of a remotely-located sensor;
b. texturing each virtual panorama onto a virtual display medium;
c. positioning each virtual display medium in a virtual environment wherein a relative position of each virtual display medium in the virtual environment corresponds to a relative position of a remotely-located sensor in physical space; and
d. providing a view of the textured virtual display mediums from a movable, virtual point of observation in the virtual environment, wherein a segment of each of virtual display medium represents a live feed from the remotely-located sensor that corresponds to the current orientation of the remotely-located sensor, and the rest of the provided view of the virtual display medium represents previously captured, and yet to be captured, portions of an environment of the remotely-located sensor that surround the portion of the environment shown in the live feed.

18. An improved human-sensor system for allowing an observer to perceive and control a sensor network defined by a plurality of sensors located at various physical locations in the real world, wherein each sensor transmits a data feed, the improvement comprising a computer generated, virtual environment that is populated by one or more virtual sensor representations, wherein each sensor representation corresponds to a sensor in the sensor network and the spatial relationships between the sensor representations in the virtual environment correspond to the spatial relationships between the sensors in the real world.

19. The improved human-sensor system in accordance with claim 18, wherein each virtual sensor representation comprises a virtual surface displaying a panoramic representation of a viewable field of the sensor representation's corresponding sensor, wherein the panoramic representation is updated with the live data feed from the sensor.

20. The improved human-sensor system in accordance with claim 19, further comprising a movable, virtual point of observation within the virtual environment, wherein a view from the virtual point of observation into the virtual environment is displayed to an observer.

21. The improved human-sensor system in accordance with claim 17, further comprising a spherical control interface for controlling the movement of the virtual point of observation within the virtual environment, the spherical control interface comprising:
a. a translating control arm pivotably mounted to a pedestal at a fixed point of rotation, wherein a human user can manually extend and retract the control arm and can manipulate an orientation of the control arm relative to the fixed point of rotation;
b. means for measuring the orientation of the control arm relative to the fixed point of rotation; and
c. means for measuring the degree of extension of the control arm;
wherein an orientation of the virtual point of observation relative to a fixed point of rotation in the virtual environment mimics the orientation of the control arm relative to the fixed point of rotation on the control interface, and the distance between the virtual point of observation and the fixed point of rotation in the virtual environment varies in accordance with the degree of extension of the control arm.

22. The improved human-sensor system in accordance with claim 21, further comprising a means for moving the fixed point of rotation in the virtual environment.

23. The improved human-sensor system in accordance with claim 21, further comprising a means for selecting a sensor representation in the virtual environment to place the remotely-located sensor associated with that sensor representation under direct control of the spherical control interface.

24. The improved human-sensor system in accordance with claim 23, wherein the means for selecting a sensor representation in the virtual environment comprises a control boundary surrounding each sensor representation in the virtual environment, wherein moving the virtual point of observation into the control boundary of a sensor representation moves the fixed point of rotation in the virtual space to the virtual location of the sensor associated with that sensor representation and places the remotely-located sensor associated with that sensor representation under the control of the spherical control interface.
